(19) United States
(12) Patent Application Publication
(10) Pub. No.: US 2014/0376773 A1
(43) Pub. Date: Dec. 25, 2014

(54) TUNABLE OPERATIONAL PARAMETERS IN MOTION-CAPTURE AND TOUCHLESS INTERFACE OPERATION

(71) Applicant: LEAP MOTION, INC., San Francisco, CA (US)

(72) Inventor: David HOLZ, San Francisco, CA (US)

(73) Assignee: LEAP MOTION, INC., San Francisco, CA (US)

(21) Appl. No.: 14/311,166

(22) Filed: Jun. 20, 2014

Related U.S. Application Data
(60) Provisional application No. 61/837,975, filed on Jun. 21, 2013.

(51) Int. Cl. G06K 9/00

(52) U.S. Cl. CPC G06K 9/00342
USPC 382/103

(57) ABSTRACT

The technology disclosed can provide for improved motion capture and touchless interface operations by enabling tunable control of operational parameters without compromising the quality of image based recognition, tracking of conformation and/or motion, and/or characterization of objects (including objects having one or more articulating members (i.e., humans and/or animals and/or machines). Examples of tunable operational parameters include frame rate, field of view, contrast detection, light source intensity, pulse rate, and/or clock rate. Among other aspects, operational parameters can be changed based upon detecting presence and/or motion of an object indicating input (e.g., control information, input data, etc.) to the touchless interface, either alone or in conjunction with presence (or absence or degree) of one or more condition(s) such as accuracy conditions, resource conditions, application conditions, others, and/or combinations thereof.

### RELATED APPLICATIONS

This application is related to U.S. Nonprovisional patent application Ser. No. 14/149,663, entitled, “IMPROVING POWER CONSUMPTION IN MOTION-CAPTURE SYSTEMS,” filed on Jan. 7, 2014 (Attorney Docket No. LEAP 1028-2/LPM-006US), which claims the benefit of U.S. Provisional Patent Application No. 61/749,638, entitled “IMPROVING POWER CONSUMPTION IN MOTION-CAPTURE SYSTEMS,” filed on Jan. 7, 2013 (Attorney Docket No. LEAP 1028-1/LPM-006PR). The related applications are hereby incorporated by reference for all purposes.

This application claims the benefit of U.S. Provisional Patent Application No. 61/837,975, entitled, “TUNABLE OPERATIONAL PARAMETERS IN MOTION-CAPTURE AND TOUCHLESS INTERFACE OPERATION,” filed on Jun. 21, 2013 (Attorney Docket No. LEAP 1049-1/LPM-006PR2). The provisional application is hereby incorporated by reference for all purposes.

### INCORPORATIONS

Materials incorporated by reference in this filing include the following:

“DETERMINING POSITIONAL INFORMATION FOR AN OBJECT IN SPACE”, U.S. Non. Prov. application Ser. No. 14/214,605, filed 14 Mar. 2014 (Attorney Docket No. LEAP 1000-4/LMP-016US),

“RESOURCE-RESPONSIVE MOTION CAPTURE”, U.S. Non. Prov. application Ser. No. 14/214,569, filed 14 Mar. 2014 (Attorney Docket No. LEAP 1041-2/LPM-017US),

“PREDICTIVE INFORMATION FOR FREE SPACE GESTURE CONTROL AND COMMUNICATION”, U.S. Prov. App. No. 61/873,758, filed 4 Sep. 2013 (Attorney Docket No. LEAP 1007-1/LMP-1007APR),

“VELOCITY FIELD INTERACTION FOR FREE SPACE GESTURE INTERFACE AND CONTROL”, U.S. Prov. App. No. 61/891,880, filed 16 Oct. 2013 (Attorney Docket No. LEAP 1008-1/1009APR),

“INTERACTIVE TRAINING RECOGNITION OF FREE SPACE GESTURES FOR INTERFACE AND CONTROL”, U.S. Prov. App. No. 61/872,538, filed 30 Aug. 2013 (Attorney Docket No. LPM-013GPR),

“DRIFT CANCELLATION FOR PORTABLE OBJECT DETECTION AND TRACKING”, U.S. Prov. App. No. 61/938,635, filed 11 Feb. 2014 (Attorney Docket No. LPM-1037PR),

“IMPROVED SAFETY FOR WEARABLE VIRTUAL REALITY DEVICES VIA OBJECT DETECTION AND TRACKING”, U.S. Prov. App. No. 61/981,162, filed 17 Apr. 2014 (Attorney Docket No. LPM-1050PR),

“WEARABLE AUGMENTED REALITY DEVICES WITH OBJECT DETECTION AND TRACKING”, U.S. Prov. App. No. 62/001,044, filed 20 May 2014 (Attorney Docket No. LPM-1061PR),

“METHODS AND SYSTEMS FOR IDENTIFYING POSITION AND SHAPE OF OBJECTS IN THREE-DIMENSIONAL SPACE”, U.S. Prov. App. No. 61/587,554, filed 17 Jan. 2012,

“SYSTEMS AND METHODS FOR CAPTURING MOTION IN THREE-DIMENSIONAL SPACE”, U.S. Prov. App. No. 61/724,091, filed 8 Nov. 2012,

“NON-TACTILE INTERFACE SYSTEMS AND METHODS”, U.S. Prov. App. No. 61/816,487, filed 30 Aug. 2013 (Attorney Docket No. LPM-028PR),

“DYNAMIC USER INTERACTIONS FOR DISPLAY CONTROL”, U.S. Prov. App. No. 61/752,725, filed 15 Jan. 2013,

“WEARABLE AUGMENTED REALITY DEVICES WITH OBJECT DETECTION AND TRACKING”, U.S. Prov. App. No. 62/001,044, filed 20 May 2014,

“VEHICLE MOTION SENSORY CONTROL”, U.S. Prov. App. No. 62/005,981, filed 30 May 2014,

“MOTION CAPTURE USING CROSS-SECTIONS OF AN OBJECT”, U.S. application Ser. No. 13/414,485, filed 7 Mar. 2012, and

“SYSTEM AND METHODS FOR CAPTURING MOTION IN THREE-DIMENSIONAL SPACE”, U.S. application Ser. No. 13/742,953, filed 16 Jan. 2013.

### FIELD OF THE TECHNOLOGY DISCLOSED

The technology disclosed relates generally to imaging, and in particular to capturing information from three-dimensional objects in touchless interface operations.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Motion capture techniques generally capture movement of a subject in three-dimensional (3D) space and translate that movement into a digital model or other representation. Motion capture can be used with complex subjects that have multiple separately articulating members whose spatial relationships change as the subject moves. For instance, if the subject is a walking person, not only does the whole body move across space, but the positions of arms and legs relative to the person's core or trunk are constantly shifting. Motion-capture systems can be designed to model this articulation.

Motion capture has numerous applications. For example, in filmmaking, digital models generated using motion capture can be used as the basis for the motion of computer-generated characters or objects. In sports, motion capture can be used by coaches to study an athlete's movements and guide the athlete toward improved body mechanics. In video games or virtual reality applications, motion capture facilitates interaction with a virtual environment in a natural way, e.g., by waving to a character, pointing at an object, or performing an action such as swinging a golf club or baseball bat.

Unfortunately, conventional motion capture approaches suffer a variety of drawbacks that can render these approaches ill-suited for use with touchless interface operation. In order to accurately track motion in real or near-real time, motion capture hardware can operate at resource intensive rates; rendering employment of these conventional approaches impractical or economically infeasible in many applications. Resource requirements of motion-capture systems become more stringent when hosted by devices are operated in more demanding modes (e.g., noisy environments, portable devices powered by batteries, etc.).

Therefore, there is a need for improving operational parameters of motion-capture systems, preferably in a manner that does not affect motion-tracking performance.

### SUMMARY

The technology disclosed can provide for improved motion capture and touchless interface operations by enabling tunable control of operational parameters without compromising the quality of image based recognition, tracking of conformation and/or motion, and/or characterization of objects (including objects having one or more articulating members (i.e., humans and/or animals and/or machines). Examples of tunable operational parameters include frame rate, field of view, contrast detection, light source intensity, pulse rate, and/or clock rate. Among other aspects, operational parameters can be changed based upon detecting presence and/or motion of an object indicating input (e.g., control information, input data, etc.) to the touchless interface, either alone or in conjunction with presence (or absence or degree) of one or more condition(s) such as accuracy conditions, resource conditions, application conditions, others, and/or combinations thereof.

Advantageously, some implementations can provide for improved interface with computing and/or other machinery than would be possible with heretofore known techniques. In some implementations, a richer human-machine interface experience can be provided. The following detailed description together with the accompanying drawings will provide a better understanding of the nature and advantages provided for by implementations.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 illustrates an exemplary gesture-recognition system.

FIG. 2 is a simplified block diagram of a computer system implementing a gesture-recognition apparatus according to the technology disclosed.

FIG. 3 depicts a representative method of operating a motion-capture system in response to changing environmental conditions.

FIG. 4 shows one example of automatically tuning operational parameters of a touchless interface in response to changing interface conditions.

FIG. 5 is a flowchart showing a method of changing operational parameters of a motion-capture system based upon detecting presence and/or motion of an object indicating input.

FIG. 6 illustrates a suitable control method to control a system's operational mode.

FIGS. 7 and 8 illustrate other control methods to control a system's power mode of operation.

### DESCRIPTION

### Introduction

The technology disclosed can provide for improved motion capture and touchless interface operations by enabling tunable control of operational parameters without compromising the quality of image based recognition, tracking of conformation and/or motion, and/or characterization of objects (including objects having one or more articulating members (i.e., humans and/or animals and/or machines). Examples of tunable operational parameters include frame rate, field of view, contrast detection, light source intensity, pulse rate, and/or clock rate. Among other aspects, operational parameters can be changed based upon detecting presence and/or motion of an object indicating input (e.g., control information, input data, etc.) to the touchless interface, either alone or in conjunction with presence (or absence or degree) of one or more condition(s) such as accuracy conditions, resource conditions, application conditions, others, and/or combinations thereof.

In example scenarios, implementations can change settings based upon (i) presence and/or motion indicating input alone (i.e., detecting a hand ready to make a gesture and switching to an active mode to capture the gesture), (ii) condition information alone (i.e., detecting an application displays a complex interface—e.g., large number of active spots or hypertext links, fine detail work, etc. and changing to faster frame rate to enhance discrimination); (iii) combinations of presence and/or motion indicating input combined with condition information (i.e., detecting motion of a hand prosthesis of a handicapped user and changing to filter out greater involuntary hand movements); (iv) multiple presence and/or motion indicating input (i.e., detecting multiple hands and switching to wider field of view); and/or (v) multiple conditions (i.e., operating on batteries and wireless operation and switching to lower power usage settings); (vi) other detectable conditions; and/or (vii) various combinations of the foregoing.

Various implementations can provide continuously variable parameter tuning (e.g., “throttle” like control of a parameter through various levels), mode change (e.g., high accuracy mode vs. low resource mode, etc.), combinations of operational parameters (e.g., frame rate with field of view, etc.), user settable values for parameter(s), pre-set values for parameters, etc. Implementations can achieve improved resource (e.g., power, processor load, etc.) utilization, lower thermal noise, longer-lasting parts (i.e., less wear), lower bandwidth requirements for sending messages from the system, greater user control, etc.

In an implementation and by way of example, a method of operating a touchless interface includes viewing a region of space for one or more of a presence, a translation, and a rotation of an object (or of the viewer in relation to the object) indicating control information (e.g., control input, data input, input to an operating system, input to a non-operating system application, other input and/or combinations thereof) is available to the touchless interface is part of the method. A first setting of one or more operational parameter(s) (e.g., low frame rate, large field of view, low contrast detection, low light source intensity and/or slow pulse rate, low clock rate, etc.) of the touchless interface can be used for this viewing. The method further includes detecting an occurrence of one or more of a presence, a translation, and a rotation of an object (or the viewer relative to the object) in the region of space.

Further, the method includes changing the one or more operational parameter(s) of the touchless interface to a second setting of the operational parameter(s) (e.g., higher frame rate, narrower field of view, higher contrast detection, higher light source intensity and/or faster pulse rate, greater clock rate, etc.); thereby enabling the touchless interface to receive the control information. Of course, implementations can change from settings involving higher frame rates, narrower fields of view, higher contrast detection, higher light source intensity and/or faster pulse rates, greater clock rates, etc. to settings involving lower frame rates, larger fields of view, lower contrast detection, low light source intensity and/or slower pulse rates, low clock rates, etc. as well.

Implementations can include receiving information about any of a wide variety of conditions. Accuracy conditions include without limitation the type of work being conducted with the touchless interface (i.e., eye-surgery vs. spinning the globe in Google Earth™), and others, and/or combinations thereof. Resource conditions include without limitation bandwidth, mode of operation (wireless or wired), internet connectivity, power source(s) available, others, and/or combinations thereof. Application conditions include without limitation software and/or hardware being interacted with via the touchless interface (i.e., MS Office™ vs. Google Earth™), complexity of the touchless interface and/or of a user interface used in conjunction with the touchless interface. Complexity can include for example, density and/or numerosity of virtual objects transmitted for display across the touchless interface, number of controls, degree of complexity of the control (i.e., simple knob vs. more involved keyboard or keypad entry), changes in control inputs under direction of software, granularity of controls, i.e., the number of objects available to the user to select from and/or the size and/or closeness of the objects displayed to the user for selection, and others, and/or combinations thereof.

The motion detection that triggers a “wake-up” of the motion-capture system can be accomplished in several ways. In some implementations, images captured by the camera(s) at a very low frame rate are analyzed for the presence or movement of objects of interest. In other implementations, the system includes additional light sensors, e.g., located near the camera(s), that monitor the environment for a change in brightness indicative of the presence of an object. For example, in a well-lit room, a person walking into the field of view near the camera(s) can cause a sudden, detectable decrease in brightness. In a modified implementation applicable to motion-capture systems that illuminate the object of interest for contrast-enhancement, the light source(s) used for that purpose in motion-tracking mode are blinked, and reflections from the environment captured; in this case, a change in reflectivity can be used as an indicator that an object of interest has entered the field of view.

In some implementations, the motion-capture system can operate in intermediate modes with different rates of image capture and image analysis. For example, the system can “throttle” the rate of image capture based on the speed of the detected motion and/or the time interval between successive motions, or the rate can be reset in real time by the user, in order to maximally conserve power.

In an implementation and by way of example, frame-rate can be dynamically adjusted (e.g., increased, decreased) based on the speed of a moving object being tracked. For example, one implementation determines a target frame rate by the equation 3*Sqrt (100+maximum observed speed). Further, a minimum allowed frame-rate (i.e., 100) can be adjusted based upon one or more conditions (e.g., whether the computer is plugged into a wall socket, is a laptop/desktop, etc.).

Techniques for determining positional, shape and/or motion information about an object are described in co-pending U.S. Ser. Nos. 13/414,485, filed Mar. 7, 2012, and 61/587,554, filed Jan. 17, 2012, the entire disclosures of which are hereby incorporated by reference as if reproduced verbatim beginning here.

As used herein, a given signal, event or value is “responsive to” a predecessor signal, event or value of the predecessor signal, event or value influenced by the given signal, event or value. If there is an intervening processing element, step or time period, the given signal, event or value can still be “responsive to” the predecessor signal, event or value. If the intervening processing element or step combines more than one signal, event or value, the signal output of the processing element or step is considered “responsive to” each of the signal, event or value inputs. If the given signal, event or value is the same as the predecessor signal, event or value, this is merely a degenerate case in which the given signal, event or value is still considered to be “responsive to” the predecessor signal, event or value. “Responsiveness” or “dependency” or “basis” of a given signal, event or value upon another signal, event or value is defined similarly.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

### Gesture Recognition System

As used herein, “touchless interface” means any device (or combination of devices), software, and/or combinations thereof that does not require physical contact to receive information; that a particular interface can also be operated to perceive physical contact and/or receive information from such physical contact does not bar such an interface from being a touchless interface.

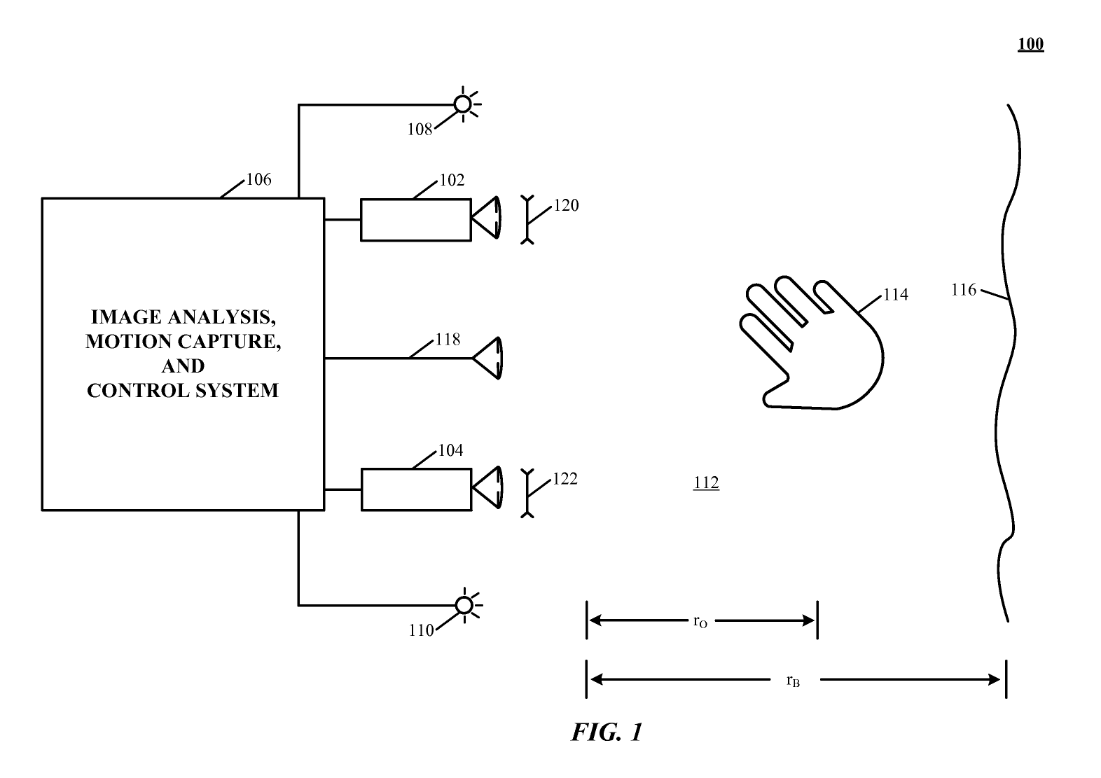

Referring first to FIG. 1, which illustrates an exemplary gesture recognition system 100 including any number of cameras 102, 104 coupled to an image and image analysis, motion capture, and control system 106 (The system 106 is hereinafter variably referred to as the “image analysis and motion capture system,” the “image analysis system,” the “motion capture system,” the “control and image-processing system,” the “control system,” or the “image-processing system,” depending on which functionality of the system is being discussed.). Cameras 102, 104 can be any type of cameras, including cameras sensitive across the visible spectrum or, more typically, with enhanced sensitivity to a confined wavelength band (e.g., the infrared (IR) or ultraviolet bands); more generally, the term “camera” herein refers to any device (or combination of devices) capable of capturing an image of an object and representing that image in the form of digital data. While illustrated using an example of a two camera implementation, other implementations are readily achievable using different numbers of cameras or non-camera light sensitive image sensors or combinations thereof. For example, line sensors or line cameras rather than conventional devices that capture a two-dimensional (2D) image can be employed. Further, the term “light” is used generally to connote any electromagnetic radiation, which can or may not be within the visible spectrum, and can be broadband (e.g., white light) or narrowband (e.g., a single wavelength or narrow band of wavelengths).

Cameras 102, 104 are preferably capable of capturing video images (i.e., successive image frames at a constant rate of at least 15 frames per second); although no particular frame rate is required. The capabilities of cameras 102, 104 are not critical to the technology disclosed, and the cameras can vary as to frame rate, image resolution (e.g., pixels per image), color or intensity resolution (e.g., number of bits of intensity data per pixel), focal length of lenses, depth of field, etc. In general, for a particular application, any cameras capable of focusing on objects within a spatial volume of interest can be used. For instance, to capture motion of the hand of an otherwise stationary person, the volume of interest can be defined as a cube approximately one meter on a side.

In some implementations, the illustrated system 100 includes one or more sources 108, 110, which can be disposed to either side of cameras 102, 104, and are controlled by image analysis and motion capture system 106. In one implementation, the sources 108, 110 are light sources. For example, the light sources can be infrared light sources, e.g., infrared light emitting diodes (LEDs), and cameras 102, 104 can be sensitive to infrared light. Use of infrared light can allow the gesture recognition system 100 to operate under a broad range of lighting conditions and can avoid various inconveniences or distractions that can be associated with directing visible light into the region where the person is moving. However, a particular wavelength or region of the electromagnetic spectrum can be required. In one implementation, filters 120, 122 are placed in front of cameras 102, 104 to filter out visible light so that only infrared light is registered in the images captured by cameras 102, 104. In another implementation, the sources 108, 110 are sonic sources providing sonic energy appropriate to one or more sonic sensors (not shown in FIG. 1 for clarity sake) used in conjunction with, or instead of, cameras 102, 104. The sonic sources transmit sound waves to the user; with the user either blocking (“sonic shadowing”) or altering the sound waves (“sonic deflections”) that impinge upon her. Such sonic shadows and/or deflections can also be used to detect the user's gestures and/or provide presence information and/or distance information using ranging techniques. In some implementations, the sound waves are, for example, ultrasound, that are not audible to humans.

It should be stressed that the arrangement shown in FIG. 1 is representative and not limiting. For example, lasers or other light sources can be used instead of LEDs. In implementations that include laser(s), additional optics (e.g., a lens or diffuser) can be employed to widen the laser beam (and make its field of view similar to that of the cameras). Useful arrangements can also include short-angle and wide-angle illuminators for different ranges. Light sources are typically diffuse rather than specular point sources; for example, packaged LEDs with light-spreading encapsulation are suitable.

In operation, light sources 108, 110 are arranged to illuminate a region of interest 112 that includes an entire control object or its portion 114 (in this example, a hand) that can optionally hold a tool or other object of interest. Cameras 102, 104 are oriented toward the region 112 to capture video images of the hand 114. In some implementations, the operation of light sources 108, 110 and cameras 102, 104 is controlled by the image analysis and motion capture system 106, which can be, e.g., a computer system, control logic implemented in hardware and/or software or combinations thereof. Based on the captured images, image analysis and motion capture system 106 determines the position and/or motion of hand 114.

Gesture recognition can be improved by enhancing contrast between the object of interest 114 and background surfaces like surface 116 visible in an image, for example, by means of controlled lighting directed at the object. For instance, in motion capture system 106 where an object of interest 114, such as a person's hand, is significantly closer to the cameras 102 and 104 than the background surface 116, the falloff of light intensity with distance (1/r² for point like light sources) can be exploited by positioning a light source (or multiple light sources) near the camera(s) or other image-capture device(s) and shining that light onto the object 114. Source light reflected by the nearby object of interest 114 can be expected to be much brighter than light reflected from more distant background surface 116, and the more distant the background (relative to the object), the more pronounced the effect will be. Accordingly, a threshold cut off on pixel brightness in the captured images can be used to distinguish “object” pixels from “background” pixels. While broadband ambient light sources can be employed, various implementations use light having a confined wavelength range and a camera matched to detect such light; for example, an infrared source light can be used with one or more cameras sensitive to infrared frequencies.

In operation, cameras 102, 104 are oriented toward a region of interest 112 in which an object of interest 114 (in this example, a hand) and one or more background objects 116 can be present. Light sources 108, 110 are arranged to illuminate region 112. In some implementations, one or more of the light sources 108, 110 and one or more of the cameras 102, 104 are disposed below the motion to be detected, e.g., in the case of hand motion, on a table or other surface beneath the spatial region where hand motion occurs. This is an optimal location because the amount of information recorded about the hand is proportional to the number of pixels it occupies in the camera images, and the hand will occupy more pixels when the camera's angle with respect to the hand's “pointing direction” is as close to perpendicular as possible. Further, if the cameras 102, 104 are looking up, there is little likelihood of confusion with background objects (clutter on the user's desk, for example) and other people within the cameras' field of view.

Control and image-processing system 106, which can be, e.g., a computer system, can control the operation of light sources 108, 110 and cameras 102, 104 to capture images of region 112. Based on the captured images, the image-processing system 106 determines the position and/or motion of object 114. For example, as a step in determining the position of object 114, image-analysis system 106 can determine which pixels of various images captured by cameras 102, 104 contain portions of object 114. In some implementations, any pixel in an image can be classified as an “object” pixel or a “background” pixel depending on whether that pixel contains a portion of object 114 or not. With the use of light sources 108, 110, classification of pixels as object or background pixels can be based on the brightness of the pixel. For example, the distance (r_{O}) between an object of interest 114 and cameras 102, 104 is expected to be smaller than the distance (r_{B}) between background object(s) 116 and cameras 102, 104. Because the intensity of light from sources 108, 110 decreases as 1/r², object 114 will be more brightly lit than background 116, and pixels containing portions of object 114 (i.e., object pixels) will be correspondingly brighter than pixels containing portions of background 116 (i.e., background pixels). For example, if r_{B}/r_{O}=2, then object pixels will be approximately four times brighter than background pixels, assuming object 114 and background 116 are similarly reflective of the light from sources 108, 110, and further assuming that the overall illumination of region 112 (at least within the frequency band captured by cameras 102, 104) is dominated by light sources 108, 110. These conditions generally hold for suitable choices of cameras 102, 104, light sources 108, 110, filters 120, 122, and objects commonly encountered. For example, light sources 108, 110 can be infrared LEDs capable of strongly emitting radiation in a narrow frequency band, and filters 120, 122 can be matched to the frequency band of light sources 108, 110. Thus, although a human hand or body, or a heat source or other object in the background, can emit some infrared radiation, the response of cameras 102, 104 can still be dominated by light originating from sources 108, 110 and reflected by object 114 and/or background 116.

In this arrangement, image-analysis system 106 can quickly and accurately distinguish object pixels from background pixels by applying a brightness threshold to each pixel. For example, pixel brightness in a CMOS sensor or similar device can be measured on a scale from 0.0 (dark) to 1.0 (fully saturated), with some number of gradations in between depending on the sensor design. The brightness encoded by the camera pixels scales standardly (linearly) with the luminance of the object, typically due to the deposited charge or diode voltages. In some implementations, light sources 108, 110 are bright enough that reflected light from an object at distance r_{O} produces a brightness level of 1.0 while an object at distance r_{B}=2r_{O} produces a brightness level of 0.25. Object pixels can thus be readily distinguished from background pixels based on brightness. Further, edges of the object can also be readily detected based on differences in brightness between adjacent pixels, allowing the position of the object within each image to be determined. Correlating object positions between images from cameras 102, 104 allows image-analysis system 106 to determine the location in 3D space of object 114, and analyzing sequences of images allows image-analysis system 106 to reconstruct 3D motion of object 114 using motion algorithms.

In accordance with various implementations of the technology disclosed, the cameras 102, 104 (and typically also the associated image-analysis functionality of control and image-processing system 106) are operated in a low-power mode until an object of interest 114 is detected in the region of interest 112. For purposes of detecting the entrance of an object of interest 114 into this region, the system 100 further includes one or more light sensors 118 that monitor the brightness in the region of interest 112 and detect any change in brightness. For example, a single light sensor including, e.g., a photodiode that provides an output voltage indicative of (and over a large range proportional to) a measured light intensity can be disposed between the two cameras 102, 104 and oriented toward the region of interest 112. The one or more sensors 118 continuously measure one or more environmental illumination parameters such as the brightness of light received from the environment. Under static conditions—which implies the absence of any motion in the region of interest 112—the brightness will be constant. If an object enters the region of interest 112, however, the brightness can abruptly change. For example, a person walking in front of the sensor(s) 118 can block light coming from an opposing end of the room, resulting in a sudden decrease in brightness. In other situations, the person can reflect light from a light source in the room onto the sensor, resulting in a sudden increase in measured brightness.

The aperture of the sensor(s) 118 can be sized such that its (or their collective) field of view overlaps with that of the cameras 102, 104. In some implementations, the field of view of the sensor(s) 118 is substantially co-existent with that of the cameras 102, 104 such that substantially all objects entering the camera field of view are detected. In other implementations, the sensor field of view encompasses and exceeds that of the cameras. This enables the sensor(s) 118 to provide an early warning if an object of interest approaches the camera field of view. In yet other implementations, the sensor(s) capture(s) light from only a portion of the camera field of view, such as a smaller area of interest located in the center of the camera field of view.

The control and image-processing system 106 monitors the output of the sensor(s) 118, and if the measured brightness changes by a set amount (e.g., by 10% or a certain number of candela), it recognizes the presence of an object of interest in the region of interest 112. The threshold change can be set based on the geometric configuration of the region of interest and the motion-capture system, the general lighting conditions in the area, the sensor noise level, and the expected size, proximity, and reflectivity of the object of interest so as to minimize both false positives and false negatives. In some implementations, suitable settings are determined empirically, e.g., by having a person repeatedly walk into and out of the region of interest 112 and tracking the sensor output to establish a minimum change in brightness associated with the person's entrance into and exit from the region of interest 112. Of course, theoretical and empirical threshold-setting methods can also be used in conjunction. For example, a range of thresholds can be determined based on theoretical considerations (e.g., by physical modelling, which can include ray tracing, noise estimation, etc.), and the threshold thereafter fine-tuned within that range based on experimental observations.

In implementations where the area of interest 112 is illuminated, the sensor(s) 118 will generally, in the absence of an object in this area, only measure scattered light amounting to a small fraction of the illumination light. Once an object enters the illuminated area, however, this object can reflect substantial portions of the light toward the sensor(s) 118, causing an increase in the measured brightness. In some implementations, the sensor(s) 118 is (or are) used in conjunction with the light sources 106, 108 to deliberately measure changes in one or more environmental illumination parameters such as the reflectivity of the environment within the wavelength range of the light sources. The light sources can blink, and a brightness differential be measured between dark and light periods of the blinking cycle. If no object is present in the illuminated region, this yields a baseline reflectivity of the environment. Once an object is in the area of interest 112, the brightness differential will increase substantially, indicating increased reflectivity. (Typically, the signal measured during dark periods of the blinking cycle, if any, will be largely unaffected, whereas the reflection signal measured during the light period will experience a significant boost.) Accordingly, the control system 106 monitoring the output of the sensor(s) 118 can detect an object in the region of interest 112 based on a change in one or more environmental illumination parameters such as environmental reflectivity that exceeds a predetermined threshold (e.g., by 10% or some other relative or absolute amount). As with changes in brightness, the threshold change can be set theoretically based on the configuration of the image-capture system and the monitored space as well as the expected objects of interest, and/or experimentally based on observed changes in reflectivity.

### Computer System

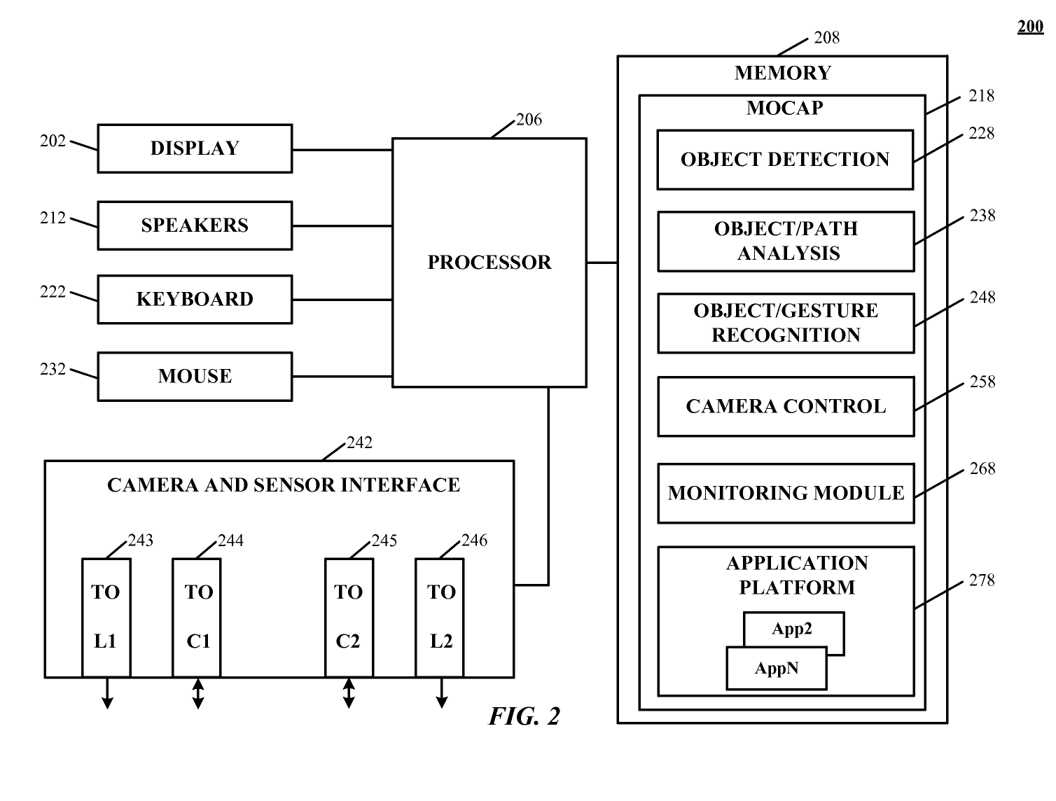

FIG. 2 is a simplified block diagram of a computer system 200, implementing all or portions of image analysis and motion capture system 106 according to an implementation of the technology disclosed. Image analysis and motion capture system 106 can include or consist of any device or device component that is capable of capturing and processing image data. In some implementations, computer system 200 includes a processor 206, memory 208, a sensor interface 242, a display 202 (or other presentation mechanism(s), e.g. holographic projection systems, wearable googles or other head mounted displays (HMDs), heads up displays (HUDs), other visual presentation mechanisms or combinations thereof, speakers 212, a keyboard 222, and a mouse 232. Memory 208 can be used to store instructions to be executed by processor 206 as well as input and/or output data associated with execution of the instructions. In particular, memory 208 contains instructions, conceptually illustrated as a group of modules described in greater detail below, that control the operation of processor 206 and its interaction with the other hardware components. An operating system directs the execution of low-level, basic system functions such as memory allocation, file management and operation of mass storage devices. The operating system can be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MAC OS operating system, the APACHE operating system, an OPENACTION operating system, iOS, Android or other mobile operating systems, or another operating system platform.

The computing environment can also include other removable/non-removable, volatile/nonvolatile computer storage media. For example, a hard disk drive can read or write to non-removable, nonvolatile magnetic media. A magnetic disk drive can read from or write to a removable, nonvolatile magnetic disk, and an optical disk drive can read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid physical arrangement RAM, solid physical arrangement ROM, and the like. The storage media are typically connected to the system bus through a removable or non-removable memory interface.

Processor 206 can be a general-purpose microprocessor, but depending on implementation can alternatively be a microcontroller, peripheral integrated circuit element, a CSIC (customer-specific integrated circuit), an ASIC (application-specific integrated circuit), a logic circuit, a digital signal processor, a programmable logic device such as an FPGA (field-programmable gate array), a PLD (programmable logic device), a PLA (programmable logic array), an RFID processor, smart chip, or any other device or arrangement of devices that is capable of implementing the actions of the processes of the technology disclosed.

Sensor interface 242 can include hardware and/or software that enables communication between computer system 200 and cameras such as cameras 102, 104 shown in FIG. 1, as well as associated light sources such as light sources 108, 110 of FIG. 1. Thus, for example, sensor interface 242 can include one or more data ports 244, 245 to which cameras can be connected, as well as hardware and/or software signal processors to modify data signals received from the cameras (e.g., to reduce noise or reformat data) prior to providing the signals as inputs to a motion-capture (“mocap”) program 218 executing on processor 206. In some implementations, sensor interface 242 can also transmit signals to the cameras, e.g., to activate or deactivate the cameras, to control camera settings (frame rate, image quality, sensitivity, etc.), or the like. Such signals can be transmitted, e.g., in response to control signals from processor 206, which can in turn be generated in response to user input or other detected events.

Sensor interface 242 can also include controllers 243, 246, to which light sources (e.g., light sources 108, 110) can be connected. In some implementations, controllers 243, 246 provide operating current to the light sources, e.g., in response to instructions from processor 206 executing mocap program 218. In other implementations, the light sources can draw operating current from an external power supply, and controllers 243, 246 can generate control signals for the light sources, e.g., instructing the light sources to be turned on or off or changing the brightness. In some implementations, a single controller can be used to control multiple light sources.

Instructions defining mocap program 218 are stored in memory 208, and these instructions, when executed, perform motion-capture analysis on images supplied from cameras connected to sensor interface 242. In one implementation, mocap program 218 includes various modules, such as an object detection module 228, an object analysis module 238, and a gesture-recognition module 248. Object detection module 228 can analyze images (e.g., images captured via sensor interface 242) to detect edges and/or features of an object therein and/or other information about the object's location. Object analysis module 238 can analyze the object information provided by object detection module 228 to determine the 3D position and/or motion of the object (e.g., a user's hand). Examples of operations that can be implemented in code modules of mocap program 218 are described below. Alternatively to being implemented in software, camera control 258 can also be facilitated by a special-purpose hardware module integrated into computer system 200. In addition, the memory 208 can include a monitoring module 268, which monitors one or more parameters associated with the system (e.g., the power source supplying power thereto) and/or the object 114 (e.g., the speed of object motion) to facilitate power-mode adjustments based thereon. Memory 208 can also include other information and/or code modules used by mocap program 218 such as an application platform 278, which allows a user to interact with the mocap program 218 using different applications like application 1 (App1), application 2 (App2), and application N (AppN).

Display 202, speakers 212, keyboard 222, and mouse 232 can be used to facilitate user interaction with computer system 200. In some implementations, results of gesture capture using sensor interface 242 and mocap program 218 can be interpreted as user input. For example, a user can perform hand gestures that are analyzed using mocap program 218, and the results of this analysis can be interpreted as an instruction to some other program executing on processor 206 (e.g., a web browser, word processor, or other application). Thus, by way of illustration, a user might use upward or downward swiping gestures to “scroll” a webpage currently displayed on display 202, to use rotating gestures to increase or decrease the volume of audio output from speakers 212, and so on.

It will be appreciated that computer system 200 is illustrative and that variations and modifications are possible. Computer systems can be implemented in a variety of form factors, including server systems, desktop systems, laptop systems, tablets, smart phones or personal digital assistants, wearable devices, e.g., goggles, head mounted displays (HMDs), wrist computers, heads up displays (HUDs) for vehicles, and so on. A particular implementation can include other functionality not described herein, e.g., wired and/or wireless network interfaces, media playing and/or recording capability, etc. In some implementations, one or more cameras can be built into the computer or other device into which the sensor is imbedded rather than being supplied as separate components. Further, an image analyzer can be implemented using only a subset of computer system components (e.g., as a processor executing program code, an ASIC, or a fixed-function digital signal processor, with suitable I/O interfaces to receive image data and output analysis results).

While computer system 200 is described herein with reference to particular blocks, it is to be understood that the blocks are defined for convenience of description and are not intended to imply a particular physical arrangement of component parts. Further, the blocks need not correspond to physically distinct components. To the extent that physically distinct components are used, connections between components (e.g., for data communication) can be wired and/or wireless as desired.

With reference to FIGS. 1 and 2, the user performs a gesture that is captured by the cameras 102, 104 as a series of temporally sequential images. In other implementations, cameras 102, 104 can capture any observable pose or portion of a user. For instance, if a user walks into the field of view near the cameras 102, 104, cameras 102, 104 can capture not only the whole body of the user, but the positions of arms and legs relative to the person's core or trunk. These are analyzed by a gesture-recognition module 248, which can be implemented as another module of the mocap 218. Gesture-recognition module 248 provides input to an electronic device, allowing a user to remotely control the electronic device and/or manipulate virtual objects, such as prototypes/models, blocks, spheres, or other shapes, buttons, levers, or other controls, in a virtual environment displayed on display 202. The user can perform the gesture using any part of her body, such as a finger, a hand, or an arm. As part of gesture recognition or independently, the image analysis and motion capture system 106 can determine the shapes and positions of the user's hand in 3D space and in real time; see, e.g., U.S. Ser. Nos. 61/587,554, 13/414,485, 61/724,091, and 13/724,357 filed on Jan. 17, 2012, Mar. 7, 2012, Nov. 8, 2012, and Dec. 21, 2012 respectively, the entire disclosures of which are hereby incorporated by reference. As a result, the image analysis and motion capture system processor 206 may not only recognize gestures for purposes of providing input to the electronic device, but can also capture the position and shape of the user's hand in consecutive video images in order to characterize the hand gesture in 3D space and reproduce it on the display screen 202.

In one implementation, the gesture-recognition module 248 compares the detected gesture to a library of gestures electronically stored as records in a database, which is implemented in the image analysis and motion capture system 106, the electronic device, or on an external storage system. (As used herein, the term “electronically stored” includes storage in volatile or non-volatile storage, the latter including disks, Flash memory, etc., and extends to any computationally addressable storage media (including, for example, optical storage).) For example, gestures can be stored as vectors, i.e., mathematically specified spatial trajectories, and the gesture record can have a field specifying the relevant part of the user's body making the gesture; thus, similar trajectories executed by a user's hand and head can be stored in the database as different gestures so that an application can interpret them differently.

### Particular Implementations

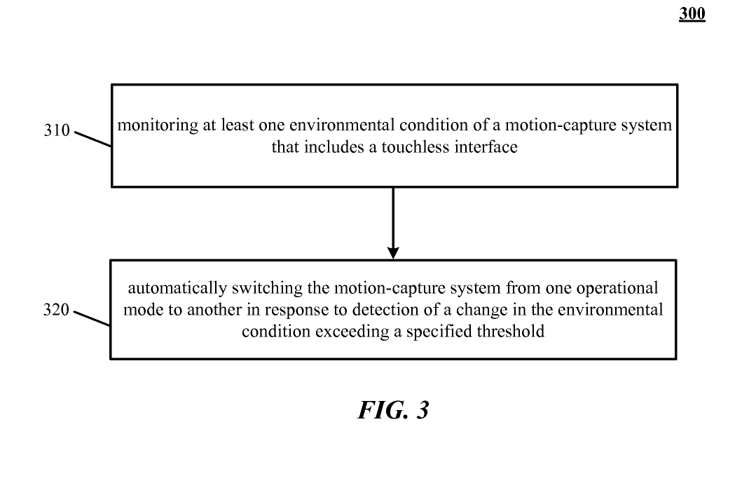

Now with reference to FIG. 3, in one implementation, a method 300 is described to operate a motion-capture system in response to changing environmental conditions. The method 300 includes monitoring at least one environmental condition of a motion-capture system that includes a touchless interface at action 310 and automatically switching the motion-capture system at action 320 from one operational mode to another in response to detection of a change in the environmental condition exceeding a specified threshold. Flowchart 300 can be implemented at least partially with and/or by one or more processors configured to receive or retrieve information, process the information, store results, and transmit the results. Other implementations can perform the actions in different orders and/or with different, fewer or additional actions than those illustrated in FIG. 3. Multiple actions can be combined in some implementations described below. For convenience, this flowchart is described with reference to the system that carries out a method. The system is not necessarily part of the method.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

In some implementations, the environmental condition refers to accuracy condition of the touchless interface based on the type of work being conducted with the touchless interface (i.e., eye-surgery vs. spinning the globe in Google Earth™. In some other implementations, the environmental condition refers to resource condition of the motion-capture system such as bandwidth, mode of operation (wireless or wired), internet connectivity, and/or power source(s) available. In other implementations, the environmental condition refers to application condition of an application interacted with using the touchless interface i.e. software and/or hardware being interacted with via the touchless interface (i.e., MS Office™ vs. Google Earth™. In yet other implementations, the environmental condition refers to interface condition of the touchless interface, including complexity of the touchless interface and/or of a user interface used in conjunction with the touchless interface. Complexity can include for example, density and/or numerosity of virtual objects transmitted for display across the touchless interface, number of controls, degree of complexity of the control (i.e., simple knob vs. more involved keyboard or keypad entry), changes in control inputs under direction of software, granularity of controls, i.e., the number of objects available to the user to select from and/or the size and/or closeness of the objects displayed to the user for selection, and others, and/or combinations thereof.

In some implementations, where the threshold change in the environmental condition is in response to at least one of presence and movement of an object of interest detected by the motion-capture system, the method further includes automatically switching the motion-capture system from a standby mode to an operational mode. In various implementations, changes in brightness or reflectivity as detected based on the sensor measurements described above are used to control the operation of the system 100 so as to minimize power consumption while assuring high-quality motion capture. Initially, according to one implementation, the control system 106 operates the cameras in a low-power mode such as a standby or sleep mode where motion capture does not take place at all or a slow image-acquisition mode (e.g., with image-acquisition rates of five frames per second or less). This does not only reduce power consumption by the cameras, but typically also decreases the power consumption of the control and image-processing system 106, which is subject to a lower processing burden as a consequence of the decreased (or vanishing) frame rate. While the system is in low-power mode, the control system 106 monitors environmental illumination parameters like environmental brightness and/or reflectivity, either continuously or at certain intervals, based on readings from the sensor(s) 118.

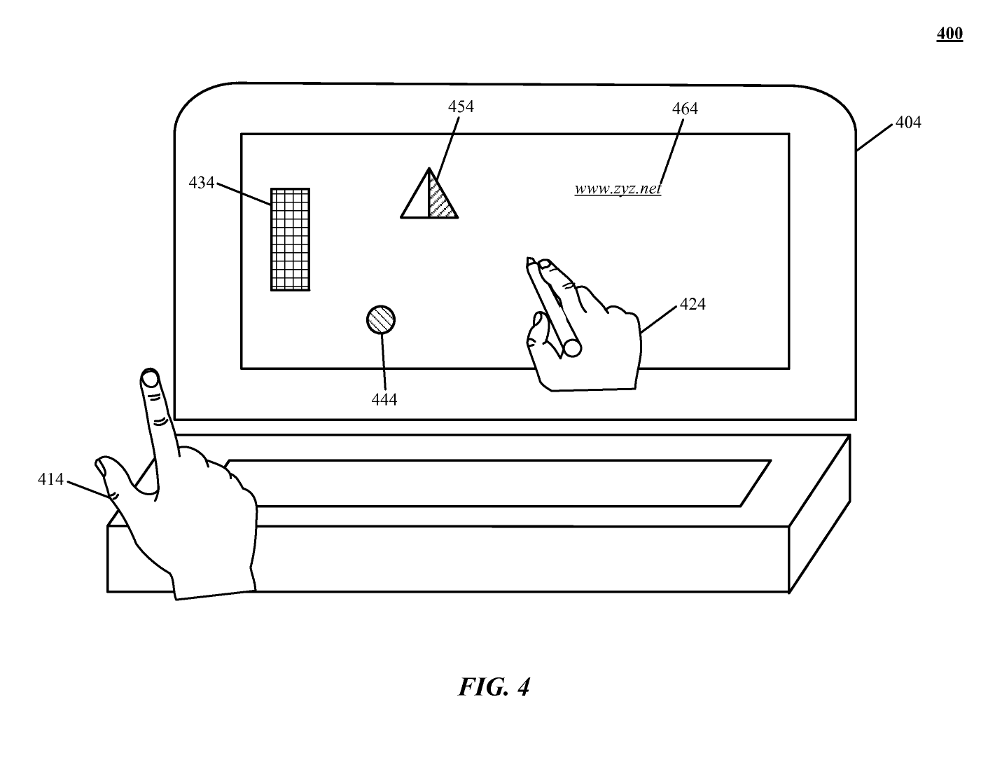

FIG. 4 shows one example 400 of automatically tuning operational parameters of a touchless interface 404 in response to changing interface conditions. As shown in FIG. 4, in example scenarios, implementations can change settings based upon (i) presence and/or motion indicating input alone such as detecting a hand 414 ready to make a gesture and switching to an active mode to capture the gesture, (ii) condition information alone i.e., detecting an application displays a complex interface 404—e.g., large number of active spots 444 and 454 or hypertext links 464, fine detail work 434, etc. and changing to faster frame rate to enhance discrimination; (iii) combinations of presence and/or motion indicating input combined with condition information i.e., detecting motion of combination 424 of a hand and held tool or a hand prosthesis of a handicapped user or tool and changing to filter out greater involuntary hand movements; (iv) multiple presence and/or motion indicating input i.e., detecting multiple hands 414 and 424 and switching to wider field of view; and/or (v) multiple conditions i.e., operating on batteries and wireless operation and switching to lower power usage settings; (vi) other detectable conditions; and/or (vii) various combinations of the foregoing.

As long as the brightness and/or reflectivity (whichever is monitored) does not change significantly (e.g., remains below the specified threshold), the system continues to be operated in low-power mode and the brightness/reflectivity continues to be monitored. Once a change in brightness and/or reflectivity is detected, the cameras (and associated image-processing functionality of the control and image-processing system 106) are switched into a high-frame-rate, high-power mode, in which motion of an object of interest 114 in the region of interest 112 is continuously tracked. Frame rates in this mode are typically at least 15 frames per second, and often several tens or hundreds of frames per second. Motion capture and tracking usually continues as long as the object of interest 114 remains within the region of interest 112.

In some implementations, where the threshold change in the environmental condition is in response to disappearance of an object of interest detected by the motion-capture system, the method further includes automatically switching the motion-capture from an operational mode to a standby mode. When the object 114 leaves the region 112 (as determined, e.g., by the image-processing system 106 based on the motion tracking, however, control system 106 switches the camera(s) back into low-power mode, and resumes monitoring the environment for changes in environmental illumination parameters like brightness and/or reflectivity.

This method can be modified in various ways in other implementations. For example, in implementations where the cameras still capture images in the low-power mode, albeit at a low frame rate, any motion detected in these images can be used, separately or in conjunction with changes in one or more environmental illumination parameters such as environmental brightness or reflectivity, to trigger the wake-up of the system.

In some implementations, where the threshold change in the environmental condition is in response to interpretation of a touchless gesture segment as input information to the motion-capture system, the method further includes automatically switching the motion-capture system from a first-illumination mode to a second-illumination mode. In one implementation, the method includes selectively illuminating the respective light sources includes varying brightness of pairs of overlapping light sources by dimming a first, initially on light source while brightening a second, initially off light source. In some implementations, the brightness of the two overlapping light sources is varied by applying a quadratic formula. In other implementations, the brightness of the two overlapping light sources according to a Gaussian distribution. In yet another implementation, the respective light sources are illuminated selectively one at a time.

In another implementation, two or more of the light sources are illuminated respectively at different intensities of illumination. In some implementations, a coarse scan of the field of view is performed to assemble a low-resolution estimate of the target object position by illuminating a subset of light sources from the plurality of light sources. In other implementations, the coarse scan is followed by performing a fine grained scan of a subsection the field of view based on the low-resolution estimate of the target object position and identifying distinguishing features of the target object based on a high-resolution data set collected during the fine grained scan. In yet another implementation, a plurality of scans of the field of view is performed and varying light properties of light are emitted from the respective light sources among the scans.

In some implementations, where the threshold change in the environmental condition is in response to detecting a battery power source supplying power to the motion-capture system, the method further includes automatically switching the motion-capture system from a first-power mode to a second-power mode. In other implementations, where the threshold change in the environmental condition is in response to detecting a plug-in power source supplying power to the motion-capture system, the method further includes automatically switching the motion-capture system from a first-power mode to a second-power mode.

In various implementations, the system 100 automatically switches the operational mode based on the source that supplies power thereto. For example, the system 100 can be powered directly or indirectly (e.g., via an electronic device) by a plug-in power source or a battery. Because the battery has a limited life during each charging cycle, it can be desirable to operate the system 100 in a power-saving mode (e.g., an intermediate-power mode or a low-power mode) when the power is supplied by a battery. In one implementation, when the system 100 detects that a battery is being utilized as the power source, the system 100 automatically switches from the high-power mode to the power-saving mode. Similarly, if a plug-in power source is detected, the system 100 can switch back to the high-power mode. In some implementations, instead of switching the power mode of operation automatically, the system 100 indicates the change of the power source to the user and requests user confirmation before changing the power mode. For example, in a situation where a battery power source is used, the user can prefer to stay in the high-power mode for providing high-resolution motion tracking, even at the cost of a shorter battery life. The user can simply indicate her intent by pressing an icon to reject the mode switch. Additionally, the system 100 can provide the user with information about the estimated remaining life of the battery associated with each power mode of operation; this enables the user to determine the operational mode based on both the resolution of motion tracking and intended interaction time. Again, the system 100 can allow the user to switch the power mode of operation anytime during her interactions therewith.

In some implementations, where the threshold change in the environmental condition is in response to determining a level of image-acquisition resources available using benchmarking of acquisition components of the motion-capture system, the method further includes automatically switching the motion-capture system from a first-image acquisition mode to a second-image acquisition mode. In some implementations, where the threshold change in the environmental condition is in response to determining a level of image-analysis resources available using benchmarking of computational components of the motion-capture system, the method further includes automatically switching the motion-capture system from a first-image analysis mode to a second-image analysis mode.

In some implementations, a benchmarking module assesses the level of computational resources available to support the operations of the mocap program 218. In one implementation, these resources can be on-board components of the computer 200 or can be, in part, external components in wired or wireless communication with the computer 200 via an I/O port or a communications module. This determination is used in optimizing motion-capture functions as described below. In particular, the benchmarking module can determine at least one system parameter relevant to processing resources e.g., the speed of the processor, the number of cores in the processor, the presence and/or speed of the GPU, the size of the graphics pipeline, the size of memory, memory throughput, the amount of cache memory associated with the processor, and the amount of graphics memory in the system. Alternatively or in addition, the benchmarking module can cause an operating system of the computer 200 to assess a throughput parameter such as bus speed and a data-transfer parameter such as USB bandwidth or the current network bandwidth or time of flight. Data-transfer parameters dictate, for example, the upper performance limit of external resources, since their effective speed cannot exceed the rate at which data is made usable to the system 100. All of these parameters are collectively referred to as “capacity parameters.”

Some capacity parameters are easily obtained by causing the operating system to query the hardware platform of the system 100, which typically contains “pedigree” information regarding system characteristics (processor type, speed, etc.). To obtain other capacity parameters, the benchmarking module can run conventional, small-scale tests on the hardware to determine (i.e., to measure directly) performance characteristics such as memory throughput, graphics pipeline, processor speed. For additional background information regarding benchmarking, reference can be made to e.g., Ehliar & Liu, “Benchmarking network processors,” available at http://www.da.isy.liu.se/pubs/ehliar/ehliar-ssocc2004.pdf, which is hereby incorporated by reference).

In other implementations, the benchmarking module can use the obtained capacity parameters in an optimization algorithm or can instead use them to query a performance database. The database contains records relating various capacity parameter levels to different image-analysis optimizations, which depend, in turn, on the type of algorithm(s) employed in image analysis. Image-analysis optimizations include varying the amount of frame data upon which an image-analysis module operates or the output resolution—e.g., in the case of the motion-capture algorithm discussed above, the density of closed curves generated to approximate the object contour (that is, the number of slices relative to the detected object size in pixels). The records in the database can also specify an accuracy level associated with a particular set of capacity parameters; if an application that utilizes the output of the mocap program 218 can tolerate a lower accuracy level than the system can theoretically provide, fewer resources can be devoted to supporting the image-analysis module in order to free them up for other tasks.

Thus, the results of the benchmarking analysis can determine the coarseness of the data provided to the image-analysis module, the coarseness of its analysis, or both in accordance with entries in the performance database. For example, while with adequate computational resources the image-analysis module can operate on every image frame and on all data within a frame, capacity limitations can dictate analysis of a reduced amount of image data per frame (i.e., resolution) or discarding of some frames altogether. If the data in each of the frame buffers is organized as a sequence of data lines, for example, the result of benchmarking can dictate using a subset of the data lines. The manner in which data is dropped from the analysis can depend on the image-analysis algorithm or the uses to which the motion-capture output is put. In some implementations, data is dropped in a symmetric or uniform fashion—e.g., every other line, every third line, etc. is discarded up to a tolerance limit of the image-analysis algorithm or an application utilizing its output. In other implementations, the frequency of line dropping can increase toward the edges of the frame. Still other image-acquisition parameters that can be varied include the frame size, the frame resolution, and the number of frames acquired per second. In particular, the frame size can be reduced by, e.g., discarding edge pixels or by resampling to a lower resolution (and utilizing only a portion of the frame buffer capacity). Parameters relevant to acquisition of image data (e.g., size and frame rate and characteristics) are collectively referred to as “acquisition parameters,” while parameters relevant to operation of the image-analysis module (e.g., in defining the contour of an object) are collectively referred to as “image-analysis parameters.” The foregoing examples of acquisition parameters and image-analysis parameters are representative only, and not limiting.

Acquisition parameters can be applied to the camera interface 242 and/or to frame buffers. The camera interface 242, for example, can be responsive to acquisition parameters in operating the cameras 102, 104 to acquire images at a commanded rate, or can instead limit the number of acquired frames passed (per unit time) to the frame buffers. Image-analysis parameters can be applied to the image-analysis module as numerical quantities that affect the operation of the contour-defining algorithm.

The optimal values for acquisition parameters and image-analysis parameters appropriate to a given level of available resources can depend, for example, on the characteristics of the image-analysis module, the nature of the application utilizing the mocap output, and design preferences. These can be reflected in the records of database so that, for example, the database has records pertinent to a number of image-processing algorithms and the benchmarking module selects the record most appropriate to the image-processing algorithm actually used. Whereas some image-processing algorithms can be able to trade off a resolution of contour approximation against input frame resolution over a wide range, other algorithms may not exhibit much tolerance at all requiring, for example, a minimal image resolution below which the algorithm fails altogether. Database records pertinent to an algorithm of the latter type can specify a lower frame rate rather than a lower image resolution to accommodate a limited availability of computational resources.

In other implementations, the benchmarking analysis can be static or dynamic. In some implementations, the benchmarking module assesses available resources upon start-up, implements the appropriate optimization, and is thereafter inactive. In yet other implementations, the benchmarking module periodically or continuously monitors one or more capacity parameters subject to variation within a use session, e.g., network bandwidth.

In some implementations, where the threshold change in the environmental condition is in response to calculating a speed of detected motion of a tracked object of interest, the method further includes automatically switching the motion-capture system from a first-image capture and analysis mode to a second-image capture and analysis mode. In other implementations, where the threshold change in the environmental condition is in response to determining time intervals between successive motions of a tracked object of interest, the method further includes automatically switching the motion-capture system from a first-image capture and analysis mode to a second-image capture and analysis mode.

In some implementations, the system 100 can operate in intermediate-power modes with different rates of image capture and image analysis based on, for example, the speed of the detected motion. For example, when the user passively interacts with the system 100 (e.g., when the user reads instructions displayed on a device associated with the system 100), the user can perform motions slowly and/or with long time intervals therebetween (e.g., scrolling down the page every 10 seconds). Upon detecting the slow movement and/or long time intervals between successive motions, the system 100 can “throttle” the rate of image capture to one of the intermediate-power modes of operation (e.g., at a frame rate of 10 frames per second) to maximally conserve power. Once the user finishes reading the instructions, she can actively interact with the system 100 (e.g., when the user interacts with a virtual environment in a video game). When the system 100 detects an increased speed of user movement, it can automatically switch to another intermediate-power mode having a higher frame rate (e.g., 15 frames per second) to accurately track the user's motion in real time and save power. If necessary, the system 100 can switch to the high-power mode to provide the highest resolution for tracking the user's movement.

Alternatively, the system 100 can allow the user to determine the mode of operation and/or frame rate manually. For example, when the system 100 detects a slow user movement, it can display a message to the user indicating that an intermediate-power mode or slower frame rate can be activated to reduce power consumption by pressing a confirmation button. The system 100 can also display an indicator showing the current operational mode and/or frame rate and allow the user to change the mode and/or frame rate arbitrarily in real time. Accordingly, the user can flexibly reset the power mode and/or frame rate of the system 100 anytime during operation to optimize the tracking results and power savings.

In some implementations, switching the motion-capture system from one operational mode to another includes at least adjusting frame size of digital image frames that capture the object of interest by altering a number of digital image frames passed per unit time to a frame buffer that stores the digital image frames.

In some implementations, switching the motion-capture system from one operational mode to another includes at least adjusting an amount of frame buffer used to store digital image frames that capture the object of interest.

In some implementations, switching the motion-capture system from one operational mode to another includes at least adjusting frame capture rate of digital image frames that capture the object of interest by altering a number of frames acquired per second.

In some implementations, switching the motion-capture system from one operational mode to another includes at least adjusting frame size by resampling to a different resolution of image data.

In some implementations, switching the motion-capture system from one operational mode to another includes at least adjusting an amount of image data analyzed per digital image frame.

In some implementations, switching the motion-capture system from one operational mode to another includes at least adjusting frame size of digital image frames that capture the object of interest by altering limits of image data acquisition on non-edge pixels.

In some implementations, switching the motion-capture system from one operational mode to another includes at least selectively illuminating respective light sources of the motion-capture system by varying brightness of pairs of overlapping light sources, selectively illuminating the respective light sources one at a time, selectively illuminating two or more of the respective light sources at different intensities of illumination, and intermittently illuminating the light sources at regular intervals.

In some implementations, switching the motion-capture system from one operational mode to another includes at least alternating a variable clock rate of the motion-capture system between two or more pre-defined frequencies.

In some implementations, where the threshold change in the environmental condition is in response to detecting input information from a plurality of distant control objects, the method further includes automatically switching the motion-capture system from a short-field of view mode to a wide-field of view mode by at least one of activating at least one wide-beam illumination element with a collective field of view similar to that of the motion-capture system and separately pointing a plurality of narrow-beam illumination elements in respective directions of the distant control objects.

In some implementations, where the threshold change in the environmental condition is in response to detecting input information from a plurality of proximate control objects, the method further includes automatically switching the motion-capture system from a wide-field of view mode to a short-field of view mode by at least collectively pointing a plurality of narrow-beam illumination elements towards the proximate control objects.

Typically, a “wide beam” is about 120° wide and a narrow beam is approximately 60° wide, although these are representative figures only and can vary with the application; more generally, a wide beam can have a beam angle anywhere from >90° to 180°, and a narrow beam can have a beam angle anywhere from >0° to 90°. For example, the detection space can initially be lit with one or more wide-beam lighting elements with a collective field of view similar to that of the tracking device, e.g., a camera. Once the object's position is obtained, the wide-beam lighting element(s) can be turned off and one or more narrow-beam lighting elements, pointing in the direction of the object, activated. As the object moves, different ones of the narrow-beam lighting elements are activated. In many implementations, these directional lighting elements only need to be located in the center of the field of view of the camera; for example, in the case of hand tracking, people will not often try to interact with the camera from a wide angle and a large distance simultaneously.

If the tracked object is at a large angle to the camera (i.e., far to the side of the motion-tracking device), it is likely relatively close to the device. Accordingly, a low-power, wide-beam lighting element can be suitable in some implementations. As a result, the lighting array can include only one or a small number of wide-beam lighting elements close to the camera along with an equal or larger number of narrow-beam devices (e.g., collectively covering the center-field region of space in front of the camera—for example, within a 30° or 45° cone around the normal to the camera). Thus, it is possible to decrease or minimize the number of lighting elements required to illuminate a space in which motion is detected by using a small number of wide-beam elements and a larger (or equal) number of narrow-beam elements directed toward the center field.

It is also possible to cover a wide field of view with many narrow-beam LEDs pointing in different directions, according to other implementations. These can be operated so as to scan the monitored space in order to identify the elements actually spotlighting the object; only these are kept on and the others turned off. In some embodiments, the motion system computes a predicted trajectory of the tracked object, and this trajectory is used to anticipate which illumination elements should be activated as the object moves. The trajectory is revised, along with the illumination pattern, as new tracking information is obtained.

In some implementations, wherein the threshold change in the environmental condition is in response to simultaneously detecting input information from an object of interest and a proximate object of non-interest, the method further includes automatically switching the motion-capture system to a filter mode by approximating a plurality of closed curves across a detected object that collectively define an object contour, determining whether the detected object is the object of interest or the object of non-interest based on the defined object contour and triggering a response to gestures performed using the object of interest without triggering a response to gestures performed using the object of non-interest.

In some implementations, the object contour is defined by capturing edge information for the object of interest 114 and computing positions of a 3D solid model for the object of interest 114. In other implementations, an object of interest 114 can be modeled as a sphere and/or ellipse, or any other kind of closed, 3D curved volume, distributed so as to volumetrically approximate the contour of the object 114. The object contour can be further used to compute a position and orientation of the object volume, which determines a shape and/or movement of the object 114.

In various implementations, the object of interest 114 is modeled as a single sphere and/or ellipse or a collection of spheres and/or ellipses; theoretically, an infinite number of spheres and/or ellipses can be used to construct the 3D model of the object 114. In one implementation, the 3D model includes spheres and/or ellipses that are close-packed (i.e., each sphere or ellipse is tangent to adjacent spheres or ellipses). Because the closed-packed spheres and/or ellipses occupy the greatest fraction of space volume of the object 114 with a limited number of spheres or ellipses, the shape and size of the object 114 can be accurately modeled with a fast processing time (e.g., milliseconds). If a higher detection resolution of the object 114 is desired, the number of spheres and/or ellipses used to model the object 114 can be increased.

In other implementations, a part of the object 114 in each partition of a sphere or ellipse can be reconstructed using a sphere or ellipse that fits the size and location thereof. A collection of spheres and/or ellipses in the partitions then determines the shape, size, and location of the object 114. In yet other implementations, pixels of light sensor(s) 118 can be grouped to form multiple regions, each of which corresponds to a spatial partition. For example, light transmitted from a part of the object 114 in the spatial partition can be projected onto a particular region of the light sensor(s) 118 to activate the pixels therein. Positions of the activated pixels in the particular region can identify the location and/or size of the object part by modeling it as, for example, a sphere and/or ellipse. In one implementation, five pixels activated by the light transmitted, reflected, or scattered from the object 114 in a partition are used to determine the location and/or size of the sphere and/or ellipse. Movements of the activated pixels in the pixel region can determine the motion of the sphere and/or ellipse (or the object part) within the spatial partition.

Movements of the activated pixels may result from a moving object part, or from a shape/size change of the object of interest 114. In some implementations, object movements are identified based on the average movement of the activated pixels and a predetermined maximum threshold movement. If, for example, the average movement of the five activated pixels is within the predetermined maximum threshold, it can be inferred that the movements of the activated pixels result from a motion of the object 114 and, consequently, object motion can be determined based on the movements of the five activated pixels. If, however, the average movement of the five activated pixels is larger than the predetermined maximum threshold, it can be inferred that the shape or size of the object part has changed and a new sphere is constructed to reflect this change. In some implementations, an angular rotation of the sphere and/or ellipse is determined based on movement of one of the five activated pixels (e.g., the fifth activated pixel) in the light sensor(s) 118. Again, if movement of the fifth activated pixel exceeds the predetermined threshold, a new sphere and/or ellipse should be used to reconstruct the object 114.

In some implementations, where the threshold change in the environmental condition is in response to detecting a graphics rich application rendered by the touchless interface, the method further includes automatically switching the motion-capture system to quick-response mode by at least one of increasing acquisition rate of image data and analysis of digital image frames that include the image data.

In some implementations, the method further includes automatically enhancing contrast between an object of interest that interacts with the touchless interface and a background by operating light sources of the motion-capture system in a pulsed mode by intermittently illuminating the light sources at regular intervals and comparing captured illuminated images with captured unilluminated images. In some implementations, light sources 108, 110 can be operated in a pulsed mode rather than being continually on. This can be useful, e.g., if light sources 108, 110 have the ability to produce brighter light in a pulse than in a steady-state operation. The shutters of cameras 102, 104 can be opened to capture images at times coincident with the light pulses, according to one implementation. Thus, an object of interest 114 can be brightly illuminated during the times when images are being captured.

In some implementations, the pulsing of light sources 108, 110 can be used to further enhance contrast between an object of interest 114 and background 116 by comparing images taken with lights 108, 110 on and images taken with lights 108, 110 off. In one implementation, light sources 108, 110 are pulsed on at regular intervals, while shutters of cameras 102, 104 are opened to capture images at times. In this case, light sources 108, 110 are “on” for every other image. If the object of interest 114 is significantly closer than background regions 116 to light sources 108, 110, the difference in light intensity will be stronger for object pixels than for background pixels. Accordingly, comparing pixels in successive images can help distinguish object and background pixels.

Contrast based object detection as described herein can be applied in any situation where objects of interest are expected to be significantly closer (e.g., half the distance) to the light source(s) than background objects. One such application relates to the use of motion detection as user input to interact with a computer system. For example, the user may point to the screen or make other hand gestures, which can be interpreted by the computer system as input.

In some implementations, where the detection of the graphics rich application is based on density of virtual objects in the touchless interface, the method further includes automatically adapting a responsiveness scale between a touchless gesture segment detected in a physical scale and resulting responses in the touchless interface based on the density of the virtual objects.

In one implementation, the gesture-recognition system 100 provides functionality for a user to statically or dynamically adjust the relationship between the user's actual motion and the resulting response, e.g., object movement displayed on the electronic device's screen. In static operation, the user manually sets this sensitivity level by manipulating a displayed slide switch or other icon using, for example, the gesture-recognition system 100 described herein. In dynamic operation, the system automatically responds to the nature of the activity being displayed, the available physical space, and/or the user's own pattern of response. For example, when an application transmits for display a complex interface, the user can adjust the relationship to a ratio smaller than one (e.g., 1:10), such that each unit (e.g., one millimeter) of the user's actual movement results in ten units (e.g., 10 pixels or 10 millimeters) of object movement displayed on the screen. Similarly, as the density of the interface increases, the user can adjust (or the device, sensing the user's distance, can autonomously adjust) the relationship to a ratio larger than one (e.g., 10:1) to compensate. Accordingly, adjusting the ratio of the user's actual motion to the resulting action (e.g., object movement) displayed on the screen provides extra flexibility for the user to control the virtual environment displayed thereon.

Other implementations can include a non-transitory computer readable storage medium storing instructions executable by a processor to perform any of the methods described above. Yet another implementation can include a system including memory and one or more processors operable to execute instructions, stored in the memory, to perform any of the methods described above.

### Example Flowcharts

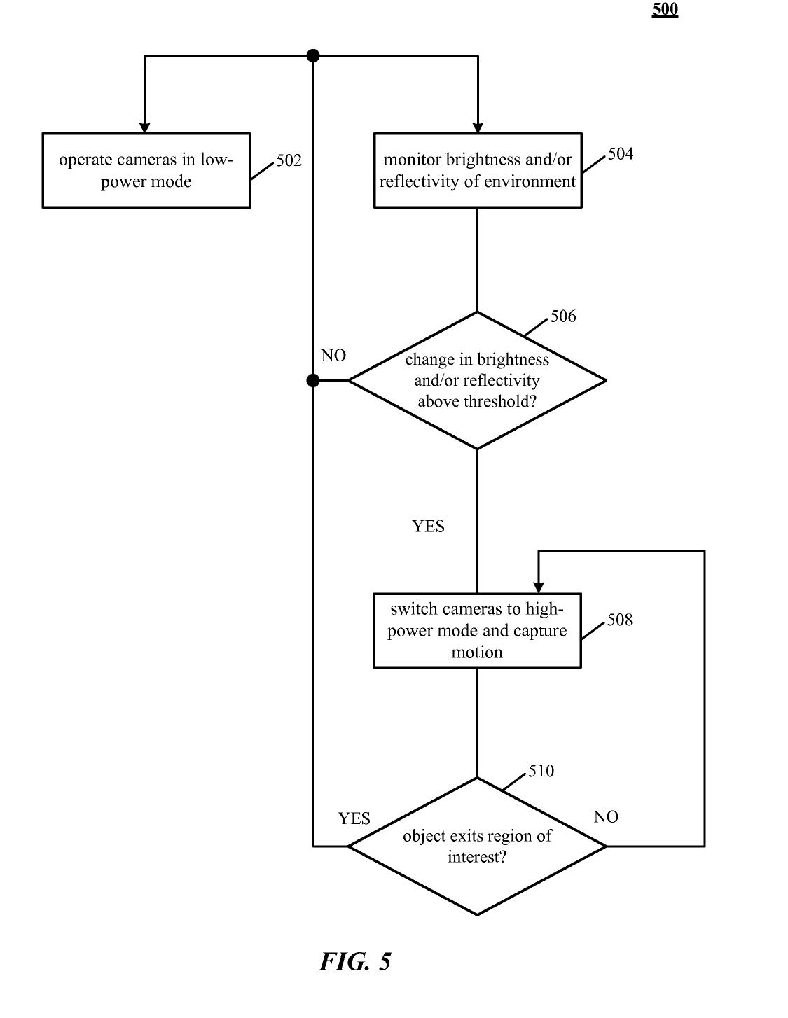

The following description illustrates examples of automatically switching the motion-capture system from one operational mode to another in response to detection of a change in the environmental condition exceeding a specified threshold. FIG. 5 is a flowchart showing a method 500 of changing operational parameters of a motion-capture system based upon detecting presence and/or motion of an object indicating input.

In various implementations, changes in brightness or reflectivity as detected based on the sensor measurements described above are used to control the operation of the system 100 so as to minimize power consumption while assuring high-quality motion capture; FIG. 5 illustrates a suitable control method 500. Initially, the control system 106 and/or the cameras 102, 104 are operated in a low-power mode (action 502), such as a stand-by or sleep mode where motion capture does not take place at all or a slow image-acquisition mode (e.g., with image-acquisition rates of five frames per second or less). This does not only reduce power consumption by the cameras, but typically also decreases the power consumption of the control and image-processing system 106, which is subject to a lower processing burden as a consequence of the decreased (or vanishing) frame rate. While the system is in low-power mode, the control system 106 monitors the environmental brightness and/or reflectivity (action 504), either continuously or at certain intervals, based on readings from the sensor(s) 118.

As long as the brightness and/or reflectivity (whichever is monitored) does not change significantly (e.g., remains below the specified threshold), the system continues to be operated in low-power mode and the brightness/reflectivity continues to be monitored. Once a change in brightness and/or reflectivity is detected (action 506), the cameras (and associated image-processing functionality of the control and image-processing system 106) are switched into a high-frame-rate, high-power mode, in which motion of an object of interest 114 in the region of interest 112 is continuously tracked (action 508). Frame rates in this mode are typically at least 15 frames per second, and often several tens or hundreds of frames per second. Motion capture and tracking usually continues as long as the object of interest 114 remains within the region of interest 112. When the object 114 leaves the region 112 (as determined, e.g., by the image-processing system 106 based on the motion tracking in action 510), however, control system 106 switches the camera(s) back into low-power mode, and resumes monitoring the environment for changes in brightness and/or reflectivity. The method 500 can be modified in various ways. For example, in implementations where the cameras still capture images in the low-power mode, albeit at a low frame rate, any motion detected in these images can be used, separately or in conjunction with changes in environmental brightness or reflectivity, to trigger the wake-up of the system.

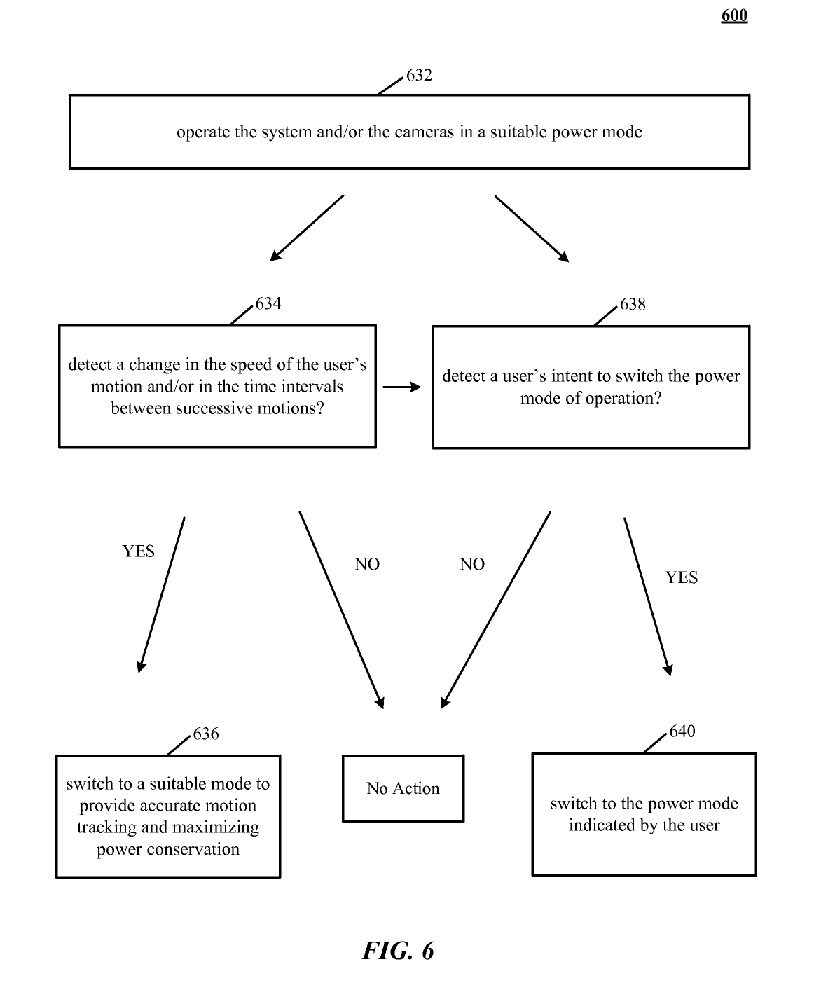

FIG. 6 illustrates a suitable control method 600 to control a system's operational mode. Initially, the control system 106 and/or the cameras 102, 104 are operated in a suitable mode (e.g., a low-power mode, a high-power mode, or an intermediate-power mode) based on the presence and/or movement of the user (action 632). Upon detecting a change in the speed of the user's motion and/or the time intervals between successive motions (action 634), the control system 106 and/or the cameras 102, 104 are switched to a suitable mode with a frame rate sufficient for providing accurate motion tracking while maximizing power conservation (action 636). Alternatively, upon detecting the user's intent to switch the power mode of operation (such as upon receiving user input directly selecting a new mode, e.g., in a menu or control panel) (action 638), the system 100 can react accordingly to satisfy the user's desire (action 640). The above-described processes can be repeated until the user finishes interacting with the system 100.

This method and other implementations of the technology disclosed can include one or more of the following features and/or features described in connection with additional methods disclosed. Other implementations can include a non-transitory computer readable storage medium storing instructions executable by a processor to perform any of the methods described above. Yet another implementation can include a system including memory and one or more processors operable to execute instructions, stored in the memory, to perform any of the methods described above.

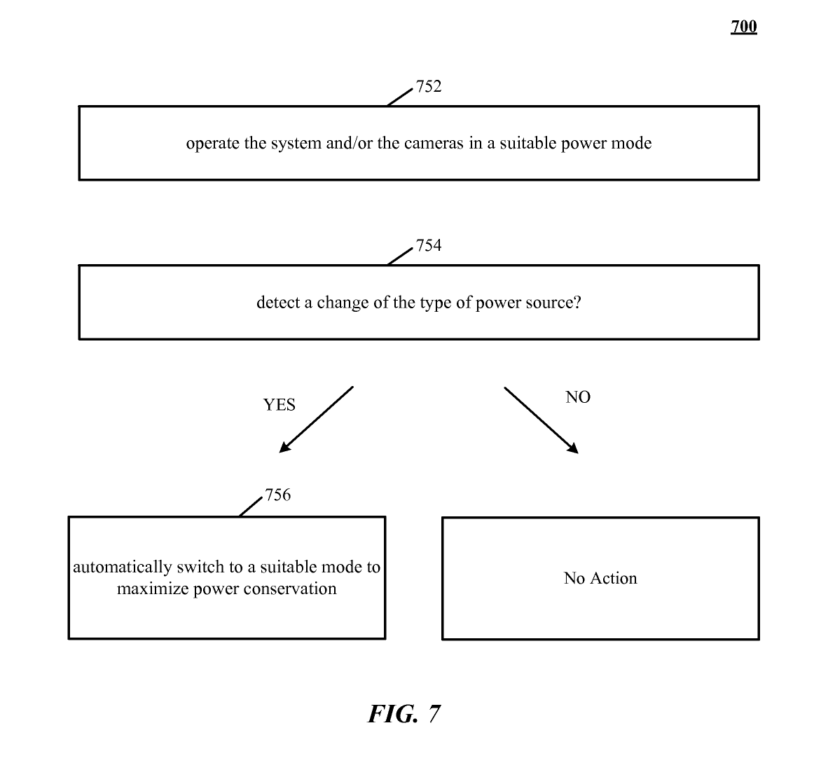

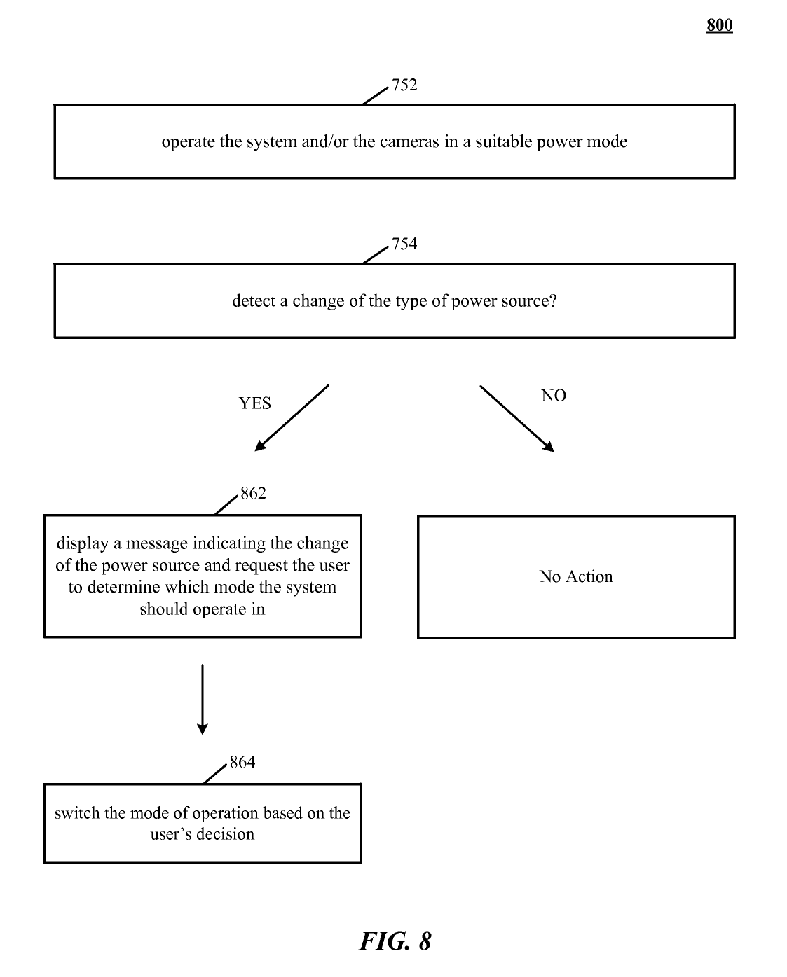

FIGS. 7 and 8 illustrate other control methods 700, 800 to control a system's power mode of operation. The control system 106 and/or the cameras 102, 104 are initially operated in a suitable mode based on a combination of the presence, movement, and/or preference of the user and the type of the power source (action 752). Upon detecting a change of the type of power source (action 754), the control system 106 and/or the cameras 102, 104 are switched to a suitable mode that reflects the change (e.g., a low-power mode for a battery power source and a high-power mode for a plug-in power source) (action 756). Alternatively, with reference to FIG. 8, the system 100 can display a message indicating the proposed change of the power source and request the user to determine which mode the system 100 should operate in (action 862). The system 100 then switches the power mode based on the user's decision (action 864). Again, the detection of the power source and possible switching of the power mode of operation can be repeated until the user completes interactions with the system 100, thereby allowing optimization of the resolution of motion tracking with reduced power consumption.

These methods and other implementations of the technology disclosed can include one or more of the following features and/or features described in connection with additional methods disclosed. Other implementations can include a non-transitory computer readable storage medium storing instructions executable by a processor to perform any of the methods described above. Yet another implementation can include a system including memory and one or more processors operable to execute instructions, stored in the memory, to perform any of the methods described above.

The terms and expressions employed herein are used as terms and expressions of description and not of limitation, and there is no intention, in the use of such terms and expressions, of excluding any equivalents of the features shown and described or portions thereof. In addition, having described certain implementations of the technology disclosed, it will be apparent to those of ordinary skill in the art that other implementations incorporating the concepts disclosed herein can be used without departing from the spirit and scope of the technology disclosed. Accordingly, the described implementations are to be considered in all respects as only illustrative and not restrictive.

What is claimed is:

1. A method of operating a motion-capture system responsive to changing environmental conditions, the method including:
monitoring at least one environmental condition of a motion-capture system that includes a touchless interface; and
in response to detection of a change in the environmental condition exceeding a specified threshold, automatically switching the motion-capture system from one operational mode to another.

2. The method of claim 1, wherein the environmental condition includes at least one of:
accuracy condition of the touchless interface,
resource condition of the motion-capture system,
application condition of an application interacted with using the touchless interface, and
interface condition of the touchless interface.

3. The method of claim 1, wherein threshold change in the environmental condition is in response to at least one of presence and movement of an object of interest detected by the motion-capture system, further including automatically switching the motion-capture system from a standby mode to an operational mode.

4. The method of claim 1, wherein the threshold change in the environmental condition is in response to disappearance of an object of interest detected by the motion-capture system, further including automatically switching the motion-capture from an operational mode to a standby mode.

5. The method of claim 1, wherein the threshold change in the environmental condition is in response to interpretation of a touchless gesture segment as input information to the motion-capture system, further including automatically switching the motion-capture system from a first-illumination mode to a second-illumination mode.

6. The method of claim 1, wherein the threshold change in the environmental condition is in response to detecting a battery power source supplying power to the motion-capture system, further including automatically switching the motion-capture system from a first-power mode to a second-power mode.

7. The method of claim 1, wherein the threshold change in the environmental condition is in response to detecting a plug-in power source supplying power to the motion-capture system, further including automatically switching the motion-capture system from a first-power mode to a second-power mode.

8. The method of claim 1, wherein the threshold change in the environmental condition is in response to determining a level of image-acquisition resources available using benchmarking of acquisition components of the motion-capture system, further including automatically switching the motion-capture system from a first-image acquisition mode to a second-image acquisition mode.

9. The method of claim 1, wherein the threshold change in the environmental condition is in response to determining a level of image-analysis resources available using benchmarking of computational components of the motion-capture system, further including automatically switching the motion-capture system from a first-image analysis mode to a second-image analysis mode.

10. The method of claim 1, wherein the threshold change in the environmental condition is in response to calculating a speed of detected motion of a tracked object of interest, further including automatically switching the motion-capture system from a first-image capture and analysis mode to a second-image capture and analysis mode.

11. The method of claim 1, wherein the threshold change in the environmental condition is in response to determining time intervals between successive motions of a tracked object of interest, further including automatically switching the motion-capture system from a first-image capture and analysis mode to a second-image capture and analysis mode.

12. The method of claim 1, wherein switching the motion-capture system from one operational mode to another includes at least:
adjusting frame size of digital image frames that capture the object of interest by altering a number of digital image frames passed per unit time to a framer buffer that stores the digital image frames.

13. The method of claim 1, wherein switching the motion-capture system from one operational mode to another includes at least:
adjusting an amount of frame buffer used to store digital image frames that capture the object of interest.

14. The method of claim 1, wherein switching the motion-capture system from one operational mode to another includes at least:
adjusting frame capture rate of digital image frames that capture the object of interest by altering a number of frames acquired per second.

15. The method of claim 1, wherein switching the motion-capture system from one operational mode to another includes at least:
adjusting frame size by resampling to a different resolution of image data.

16. The method of claim 1, wherein switching the motion-capture system from one operational mode to another includes at least:
adjusting an amount of image data analyzed per digital image frame.

17. The method of claim 1, wherein switching the motion-capture system from one operational mode to another includes at least:
adjusting frame size of digital image frames that capture the object of interest by altering limits of image data acquisition on non-edge pixels.

18. The method of claim 1, wherein switching the motion-capture system from one operational mode to another includes at least:
selectively illuminating respective light sources of the motion-capture system by varying brightness of pairs of overlapping light sources,
selectively illuminating the respective light sources one at a time,
selectively illuminating two or more of the respective light sources at different intensities of illumination, and
intermittently illuminating the light sources at regular intervals.

19. The method of claim 1, wherein switching the motion-capture system from one operational mode to another includes at least:
alternating a variable clock rate of the motion-capture system between two or more pre-defined frequencies.

20. The method of claim 1, wherein the threshold change in the environmental condition is in response to detecting input information from a plurality of distant control objects, further including automatically switching the motion-capture system from a short-field of view mode to a wide-field of view mode by at least one of:
activating at least one wide-beam illumination element with a collective field of view similar to that of the motion-capture system, and
separately pointing a plurality of narrow-beam illumination elements in respective directions of the distant control objects.

21. The method of claim 1, wherein the threshold change in the environmental condition is in response to detecting input information from a plurality of proximate control objects, further including automatically switching the motion-capture system from a wide-field of view mode to a short-field of view mode by at least:
collectively pointing a plurality of narrow-beam illumination elements towards the proximate control objects.

22. The method of claim 1, wherein the threshold change in the environmental condition is in response to simultaneously detecting input information from an object of interest and a proximate object of non-interest, further including automatically switching the motion-capture system to a filter mode by:
approximating a plurality of closed curves across a detected object, wherein the curves collectively define an object contour;
determining whether the detected object is the object of interest or the object of non-interest based on the defined object contour; and
triggering a response to gestures performed using the object of interest without triggering a response to gestures performed using the object of non-interest.

23. The method of claim 1, wherein the threshold change in the environmental condition is in response to detecting a graphics rich application rendered by the touchless interface, further including automatically switching the motion-capture system to quick-response mode by at least one of:
increasing acquisition rate of image data, and
analysis of digital image frames that include the image data.

24. The method of claim 23, further including automatically enhancing contrast between an object of interest that interacts with the touchless interface and a background by:
operating light sources of the motion-capture system in a pulsed mode by intermittently illuminating the light sources at regular intervals; and
comparing captured illuminated images with captured unilluminated images.

25. The method of claim 23, wherein the detection of the graphics rich application is based on density of virtual objects in the touchless interface, further including:
automatically adapting a responsiveness scale between a touchless gesture segment detected in a physical scale and resulting responses in the touchless interface based on the density of the virtual objects.
